(19) United States
(12) Patent Application Publication
(10) Pub. No.: US 2016/0371574 A1
(43) Pub. Date: Dec. 22, 2016

(54) SYSTEM FOR PREVENTING INSTRUMENT RETENTION

(71) Applicant: The Johns Hopkins University, Baltimore, MD (US)

(72) Inventors: Hien NGUYEN, Baltimore, MD (US); Jonathan LEMOEL, Destin, FL (US); Brandon Jay BHASIN, Baltimore, MD (US); Jimmy SU, Baltimore, MD (US); Robert HUBBARD, Baltimore, MD (US); Sean REEDER, Baltimore, MD (US); Lisa ACKLEY, Baltimore, MD (US)

(73) Assignee: THE JOHNS HOPKINS UNIVERSITY, Baltimore, MD (US)

(21) Appl. No.: 14/889,323

(22) PCT Filed: May 6, 2014
(86) PCT No.: PCT/US2014/036973

§ 371 Date: Nov. 5, 2015

Related U.S. Application Data
(60) Provisional application No. 61/819,932, filed on May 6, 2013.

(51) Int. Cl. G06K 17/00; G06K 7/10

(52) U.S. Cl. CPC G06K 17/0022; G06K 7/10415

(57) ABSTRACT

A radio-frequency identification (RFID)-based system for automatically tracking objects used in surgical procedures, and methods of use thereof, are disclosed. More particularly, an objects monitoring system is provided that includes a set of RFID tagged-objects (e.g., RFID tagged-surgical instruments), an RFID reader, an RFID reader antenna installed in a disposable wearable article, a computing device, and optionally a centralized server. A method of operation of the presently disclosed objects monitoring system includes, but is not limited to, the steps of detecting the tagged objects during the surgical procedure and automatically generating a record and count of the “checked out” objects detecting the tagged objects upon completion of the surgical procedure and automatically generating a record and count of the “checked in” objects, automatically comparing and reconciling the record of “checked in” objects with the record of “checked out” objects, and automatically indicating the success or failure of the reconciliation process.

### CROSS-REFERENCE TO RELATED APPLICATION

This application is a PCT International Application which claims the benefit of U.S. Provisional Patent Application No. 61/819,932, filed May 6, 2013, the content of which is herein incorporated by reference in its entirety.

### BACKGROUND

It is of critical importance that the entry of objects (e.g., surgical instruments) into a surgical field and into a surgical site, as well as their removal, be carefully reconciled to avoid inadvertent retention of an object within a patient. Counting objects entering and exiting a surgical field is a conventional operating room procedure. Such practices greatly reduce the risk of an object being inadvertently retained within a patient. Such procedures typically involve the manual counting of objects entering and exiting the surgical field, as well as the visual examination of the surgical site. It is critical that such procedures be completed before the surgical site is closed. These manual processes of counting and visually examining the objects entering and exiting the surgical field, however, are prone to human error. Consequently, a risk of objects being inadvertently retained within the patient exists.

### SUMMARY

The presently disclosed subject matter generally relates to methods of accounting for instruments used in surgical procedures and, more particularly, to a radio-frequency identification (RFID)-based system for automatically tracking objects used in surgical procedures, and methods of use thereof.

In some aspects, the presently disclosed subject matter provides a system for identifying and tracking one or more objects used in a surgical procedure, the system comprising a radio-frequency identification (RFID) reader, an article worn on a user's body, e.g., a wearable sleeve, a wrist- or hand-mounted device, or a device sown or otherwise incorporated into a garment, e.g., a surgical gown or a glove, worn by the user, comprising an antenna in electrical communication with the RFID reader, or a standalone RFID antenna, and one or more RFID tags for tagging, identifying, and tracking objects used in a surgical procedure.

In other aspects, the presently disclosed subject matter provides a method for identifying and tracking one or more objects used in a surgical procedure, the method comprising: providing a radio-frequency identification (RFID) reader, an article worn on a user's body, e.g., a wearable sleeve, a wrist- or hand-mounted device, or a device sown or otherwise incorporated into a garment, e.g., a surgical gown or a glove, worn by the user, comprising an antenna in electrical communication with the RFID reader, or a standalone RFID antenna, and one or more RFID tags for tagging, identifying, and tracking objects used in a surgical procedure; detecting one or more tagged objects using the RFID reader prior to or during the surgical procedure; generating a record and count of the one or more detected tagged objects prior to or during the surgical procedure; detecting one or more tagged objects using the RFID reader after the surgical procedure; generating a record and count of the one or more detected tagged objects after the surgical procedure; reconciling the record and count of the one or more detected tagged objects prior to or during the surgical procedure to the record and count of the one or more detected tagged objects after the surgical procedure; and indicating a success or failure of the reconciliation of the record and count of the one or more detected tagged objects prior to or during the surgical procedure to the record and count of the one or more detected tagged objects after the surgical procedure.

In yet other aspects, the presently disclosed subject matter provides a method for locating one or more objects used in a surgical procedure, the method comprising: providing a radio-frequency identification (RFID) reader, a wearable article comprising an antenna or a standalone antenna in electrical communication with the RFID reader, and one or more RFID tags for tagging, identifying, and tracking objects used in a surgical procedure; scanning an area suspected of comprising one or more objects used in a surgical procedure with the RFID reader; and detecting one or more objects used in a surgical procedure.

Certain aspects of the presently disclosed subject matter having been stated hereinabove, which are addressed in whole or in part by the presently disclosed subject matter, other aspects will become evident as the description proceeds when taken in connection with the accompanying Examples and Figures as best described herein below.

### BRIEF DESCRIPTION OF THE FIGURES

Having thus described the presently disclosed subject matter in general terms, reference will now be made to the accompanying Figures, which are not necessarily drawn to scale, and wherein:

FIG. 1 illustrates a block diagram of an example of the presently disclosed objects monitoring system that uses RFID technology for automatically tracking objects used in surgical procedures;

FIG. 2 shows one example of implementing the presently disclosed objects monitoring system shown in FIG. 1;

FIG. 3, FIG. 4, and FIG. 5 show examples of a user interface of the presently disclosed objects monitoring system;

FIG. 6 illustrates a flow diagram of an example of a method of using the presently disclosed objects monitoring system to automatically track objects during surgical procedures; and

FIG. 7 illustrates a flow diagram of an example of a method of operation of the presently disclosed objects monitoring system according to a simplest configuration.

### DETAILED DESCRIPTION

The presently disclosed subject matter now will be described more fully hereinafter with reference to the accompanying Figures, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements. Indeed, many modifications and other embodiments of the presently disclosed subject matter set forth herein will come to mind to one skilled in the art to which the presently disclosed subject matter pertains having the benefit of the teachings presented in the foregoing descriptions and the associated Figures. Therefore, it is to be understood that the presently disclosed subject matter is not to be limited to the specific embodiments disclosed and that modifications and other embodiments are intended to be included within the scope of the appended claims.

I. RFID-Based System for and Method of Automatically Tracking Objects used in Surgical Procedures

The presently disclosed subject matter provides a radio-frequency identification (RFID)-based system for automatically tracking objects used in surgical procedures, and methods of use thereof. More particularly, an objects monitoring system is provided that uses RFID technology, wherein the objects, such as surgical instruments, used in a surgical procedure include RFID tags for unique identification thereof. In the RFID-based objects monitoring system, an antenna of an RFID scanner/reader is embedded in an article, e.g., a wearable sleeve, a wrist- or hand-mounted device, or a device sown or otherwise incorporated into a garment, e.g., a surgical gown or a glove, worn by the user, comprising an antenna in electrical communication with the RFID reader, or a standalone RFID antenna, worn on the person of medical personnel participating in the surgical procedure. As objects are used during the surgical procedure, the RFID tags are scanned and their respective unique identification numbers are automatically transmitted from the RFID scanner/reader to a computing device and logged in a “checked out” list. Upon completion of the surgical procedure, the objects are again scanned and logged in a “checked in” list. The “checked out” and “checked in” lists are then reconciled. In the event that the “checked out” and “checked in” lists do not reconcile, a message or alarm is automatically generated by the computing device so that appropriate action can be taken to ensure that no objects are inadvertently retained within the patient.

One aspect of the presently disclosed RFID-based objects monitoring system is that it reduces, preferably entirely eliminates, the risk of inadvertent retention of an object within a patient as compared to conventional manual processes of counting and visually examining the objects that enter and exit the surgical field.

Another aspect of the presently disclosed RFID-based objects monitoring system is that it monitors the objects used in a surgical procedure without substantially altering the workflow of the participant that is wearing the article that includes the antenna of the RFID reader/scanner that is scanning the RFID-tagged objects.

In yet another aspect of the presently disclosed RFID-based objects monitoring system, in trauma situations that can arise in the operating room, the RFID-based objects monitoring system functions automatically under these circumstances and preserves the instrument count with no additional steps on the behalf of operating room staff. By contrast, in current protocols, the instrument count is often abandoned in trauma situations.

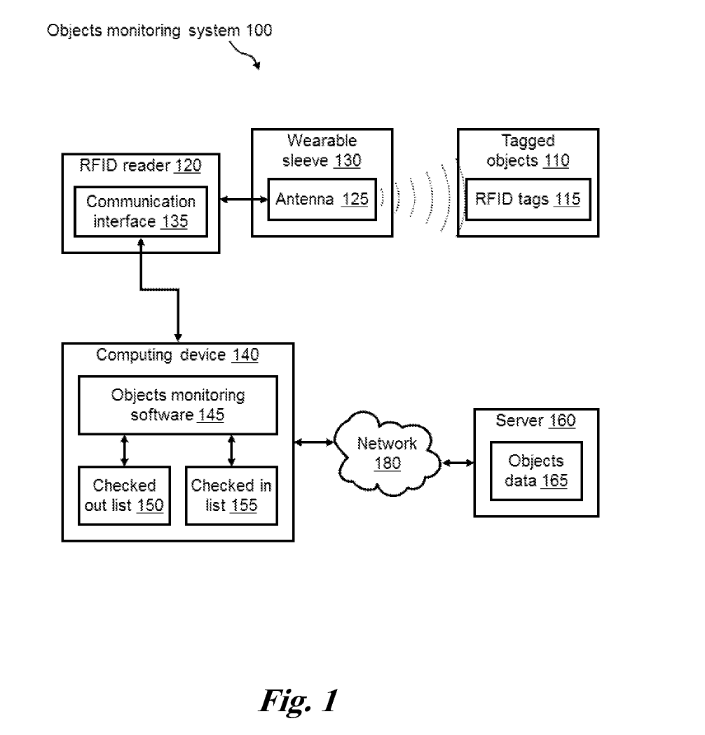

Referring now to FIG. 1, is a block diagram of an example of the presently disclosed objects monitoring system 100 that uses RFID technology for automatically tracking objects used in surgical procedures. RFID is the wireless non-contact use of radio-frequency electromagnetic fields to transfer data, for the purposes of automatically identifying and tracking tags attached to objects. For example, the objects monitoring system 100 includes a set of tagged objects 110. The tagged objects 110 are any objects that can be used in a surgical procedure, such as any types of surgical instruments. Examples of tagged objects 110 include, but are not limited to, scalpels, graspers, forceps, scissors, clamps, retractors, distractors, probes, snares, curets, needles, saws, sponges, surgical lap pads, and suction tools, as well as powered instruments, such as drills and dermatomes.

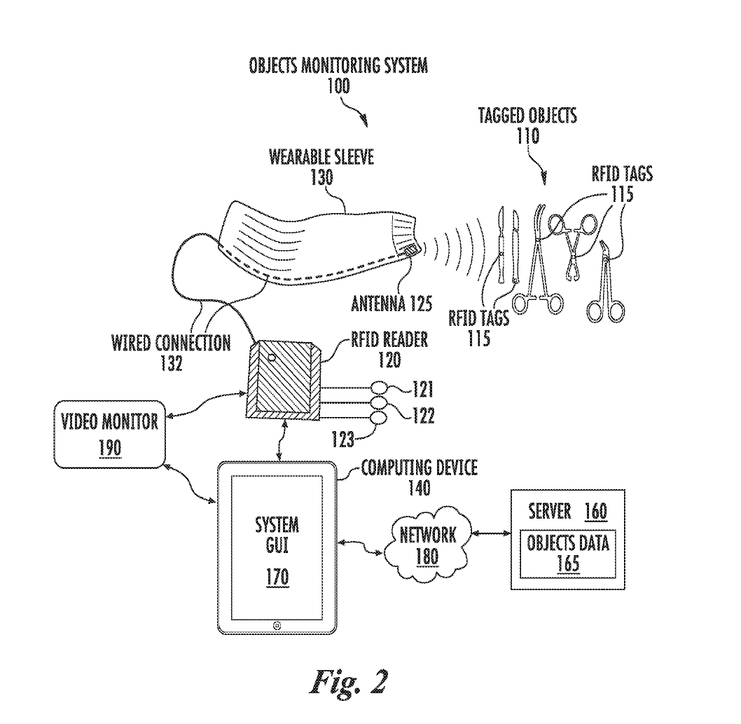

Each of the tagged objects 110 includes an RFID tag 115 that contains electronically stored information. The stored information can include a unique identification number of a given tagged object 110. In addition to the unique identification number, the stored information can include other information, such as the type and brand of object (e.g., type and brand of scalpel, grasper, or clamp). The RFID tag 115 can be a passive RFID tag that has no power supply and relies on RF energy transferred from an RFID reader to extract the stored information. For example, objects monitoring system 100 further includes an RFID reader 120 having an RFID antenna 125 that is installed or otherwise embedded into an article worn on a user's body, e.g., a wearable sleeve, a wrist- or hand-mounted device, or a device sown or otherwise incorporated into a garment, e.g., a surgical gown or a glove, worn by the user, comprising an antenna in electrical communication with the RFID reader, or a standalone RFID antenna. For illustrative purposes only, the article worn on a user's body is depicted herein as a wearable sleeve 130. In one example, the wearable sleeve 130 is a sterile, disposable sleeve that can be worn on one arm of a participant (e.g., a scrub nurse) in the surgical procedure, wherein the RFID antenna 125 is sewn, adhered, or otherwise installed into or onto the fabric of the wearable sleeve 130. An example of the wearable sleeve 130 is shown and described with reference to FIG. 2.

The RFID reader 120 and RFID antenna 125 can be any standard RFID reader/antenna device for scanning the contents of an RFID tag, such as the RFID tags 115 of the respective tagged objects 110. In particular, RFID reader 120 is used to read the unique identification number of each of the tagged objects 110. Namely, operating in combination with RFID reader 120, the antenna 125 functions as an electromagnetic inductor for the purpose of interrogating the RFID tags 115 installed in the tagged objects 110. The RFID reader 120 processes signals from the RFID tags 115 and converts them to unique identification numbers. In one example, RFID reader 120 is a portable, battery-powered RFID reader that may be clipped onto the wardrobe (e.g., the surgical gown) of the participant who is wearing the wearable sleeve 130. In some embodiments, the range of the antenna 125 is limited to, for example, a few inches, e.g., about a 6-inch radius to about a 24-inch radius, so that only the tagged objects 110 that are in close proximity to the wearable sleeve 130 will be detected and read by the RFID reader 120. The range can be adjustable by the user to control the distance of detection. In some embodiments, the antenna range has a 6-inch radius. An example of the RFID reader 120 is shown with reference to FIG. 2.

The objects monitoring system 100 further includes a computing device 140 that is in communication with the RFID reader 120. The computing device 140 is used to collect and process the information that the RFID reader 120 reads from the RFID tags 115 of the respective tagged objects 110. The computing device 140 can be any device that is capable of executing program instructions. For example, the computing device 140 may be a microcontroller device, a microprocessor device, or any computing device, such as a mobile phone, a handheld computing device, a tablet device, a laptop computer, a desktop computer, a centralized server, and the like. A certain amount of data storage (e.g., a memory device, not shown) may be associated with the computing device 140.

Further, the computing device 140 communicates with the RFID reader 120 via a wired connection or preferably via a wireless connection. For example, the RFID reader 120 includes a communication interface 135 for transmitting information from the RFID tags 115 to the computing device 140.

The communication interface 135 is implemented according to standard RF communication circuitry. In general, however, the communication interface 135 may be any wired and/or wireless communication interface for exchanging information with other devices connected to the network. Examples of wired communication interfaces may include, but are not limited to, USB ports, RS232 connectors, RJ45 connectors, Ethernet, and any combinations thereof. Examples of wireless communication interfaces may include, but are not limited to, an Intranet connection, Internet, Bluetooth® technology, Wi-Fi, Wi-Max, IEEE 802.11 technology, radio frequency (RF), Infrared Data Association (IrDA) compatible protocols, Local Area Networks (LAN), Wide Area Networks (WAN), Shared Wireless Access Protocol (SWAP), any combinations thereof, and other types of wireless networking protocols.

Further, certain objects monitoring software 145 is installed and executing on the computing device 140. The objects monitoring software 145 is used to manage the overall operations of the objects monitoring system 100 with respect to monitoring the tagged objects 110 that are used in a surgical procedure and ensuring that no tagged objects 110 are retained within a patient. Generally, the objects monitoring software 145 processes the unique identification numbers received from the RFID reader 120. The objects monitoring software 145 keeps an active count and record of the tagged objects 110, which can be accessed at any point in the surgical procedure. The objects monitoring software 145 keeps both an active checked out list and active checked in list.

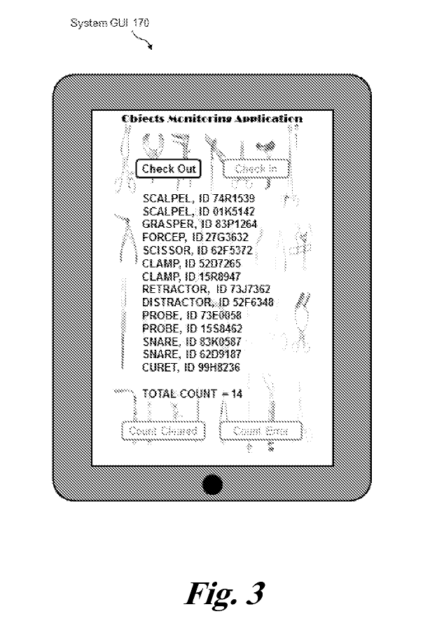

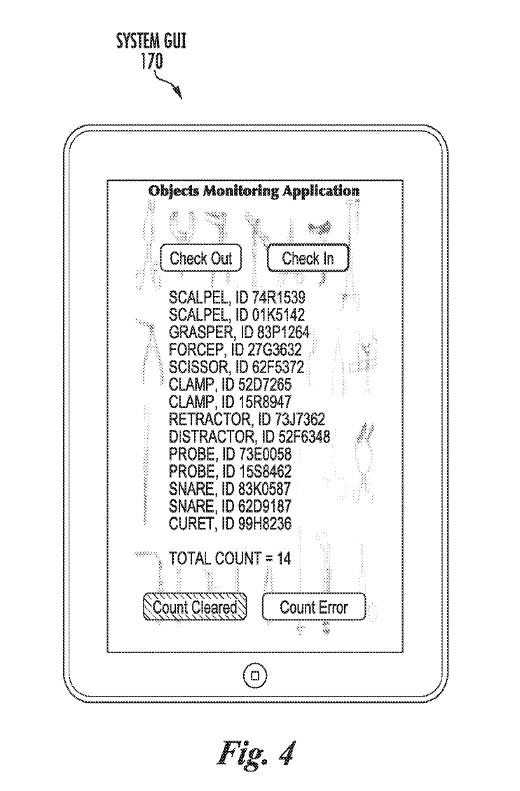

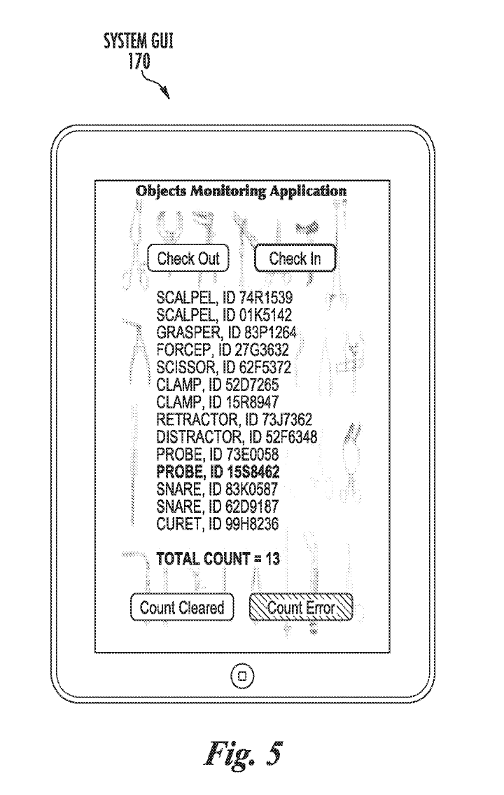

For example, in the process of monitoring the tagged objects 110, a checked out list 150 and a checked in list 155 are generated via the objects monitoring software 145. Namely, the objects monitoring software 145 automatically generates the checked out list 150 during the surgical procedure and then automatically generates the checked in list 155 at the completion of the surgical procedure. The objects monitoring software 145 then reconciles the contents of the two lists to ensure that no tagged objects 110 are retained within a patient; namely, that all of the tagged objects 110 are accounted for. In the event that the checked out list 150 and checked in list 155 do not reconcile, a message or alarm is automatically generated by the objects monitoring software 145 so that appropriate action can be taken to ensure that no tagged objects 110 are inadvertently retained within the patient. More details of the operations of the objects monitoring software 145 are described with reference to FIG. 3 through FIG. 7.

While FIG. 1 shows one set of tagged objects 110, one RFID reader 120, and one computing device 140, the objects monitoring system 100 can support a network of tagged objects 110, RFID readers 120, and computing devices 140. For example, one or more computing devices 140 can be in communication with a server 160 via a network 180. Network 180 can be any LAN and/or WAN for connecting to the Internet and/or to an Intranet via any wired or wireless means. Server 160 can be any centralized server or cloud server of, for example, a hospital. Server 160 can be used to collect information from one or more computing devices 140 about the tagged objects 110 that are used in surgical procedures performed in that hospital. Accordingly, objects data 165 is stored on server 160, wherein the objects data 165 may be the aggregated information with respect to tagged objects 110 that are used in the surgical procedures performed in that hospital.

While the server 160 and network 180 support a networking function within the objects monitoring system 100, in another embodiment, the server 160 and network 180 can be omitted from the objects monitoring system 100. In this case, the RFID reader 120 and the computing device 140 of objects monitoring system 100 are operating in a standalone, non-networked fashion.

In yet another embodiment of the objects monitoring system 100, the objects monitoring system 100 can include more than one RFID reader 120 that are connected to a common computing device 140. In this case, the objects monitoring software 145 is designed to process and reconcile information from more than one RFID reader 120. Having more than one RFID reader 120 provides redundancy within the objects monitoring system 100 and yet further ensures that no tagged objects 110 are inadvertently retained within the patient. In one example, more than one antenna 125 is installed in wearable sleeve 130, which are associated with the more than one RFID reader 120. For example, two antennas 125 are installed in wearable sleeve 130, wherein the two antennas 125 are associated with two RFID readers 120, respectively. The two RFID readers 120 are in communication with a common computing device 140.

In another example, more than one scrub nurse can be wearing a wearable sleeve 130 and with each scrub nurse having their own RFID reader 120, wherein the RFID reader 120 of each scrub nurse is in communication with a common computing device 140. For example, a first scrub nurse is wearing a first wearable sleeve 130 that is associated with a first RFID reader 120, wherein the first RFID reader 120 is in communication with the computing device 140. A second scrub nurse is wearing a second wearable sleeve 130 that is associated with a second RFID reader 120, wherein the second RFID reader 120 is in communication with the same computing device 140 that is in communication with the first RFID reader 120.

FIG. 2 shows one example of implementing the presently disclosed objects monitoring system 100 shown in FIG. 1. In this example, the tagged objects 110 are shown as medical instruments (e.g., scalpels, graspers, forceps, scissors, and the like) that have respective RFID tags 115 attached thereto.

Typical frequency bands for the presently disclosed RFID tags can range, for example, from about 100 kHz to about 500 kHz, in particular embodiments, from about 120 kHz to about 150 kHz, and in more particular embodiments, about 125 kHz to about 134.2 kHz, for small ranges of about 10 cm (about 4 inches), about 13.56 MHz for larger ranges, e.g., about 1 m (about 39 inches), or between 860 MHz to about 960 MHz, e.g., about 902 MHz to about 928 MHz, for ranges from about 1 m (about 39 inches) to about 2 m (about 78 inches). In one example, the RFID tags 115 are 125 kHz RFID tags.

For example, an RFID tag 115 can be installed at any portion of the instrument that is large enough to accommodate the RFID tag 115 and at a location that does not interfere with the operation of the instrument. The RFID tag 115 can be installed, for example, by adhering to the surface of the instrument. The RFID tag 115 is suitably encapsulated or otherwise protected so that it can withstand sterilization processes.

FIG. 2 also shows an example of the wearable sleeve 130. The wearable sleeve 130 is a sterile disposable sleeve. In this example, the wearable sleeve 130 is formed to be fitted on the user's arm and span from about the bicep area to the wrist area of the wearer. In this example, the antenna 125 is sewn, adhered, or otherwise installed into or onto the fabric of the wearable sleeve 130 near the wrist portions of the wearable sleeve 130. The antenna 125 can be implemented in wearable sleeve 130 using, for example, a coil of un-insulated copper wire.

FIG. 2 also shows an example of the RFID reader 120. In this example, the RFID reader 120 is a compact, battery-powered RFID reader that can, for example, be clipped to or held in the pocket of the surgical gown of the wearer of wearable sleeve 130 in any manner that does not impede the workflow of the user. The RFID reader 120 is non-sterile and non-disposable. Accordingly, the RFID reader 120 must be keep clear of the surgical field. RFID reader 120, in some embodiments, also can be adjoined with one or more of barcode reader 121, optical flashlight 122, and/or infrared light 123. Thus, objects monitoring system 100 also can be used to scan barcodes, scan labels requiring infrared light, and can have a flashlight function for use in dark cargo spaces. In other embodiments, barcode reader 121, optical flashlight 122, and/or infrared light 123 do not need to be physically adjoined with RFID reader 120, but other otherwise part of objects monitoring system 100. In any event, barcode reader 121, optical flashlight 122, and/or infrared light 123 are in operational communication with other relevant components of objects monitoring system 100.

A wired connection 132 is provided between RFID reader 120 and its antenna 125, which is in wearable sleeve 130. For example, an insulated flexible wire can be embedded or otherwise installed along the length of the wearable sleeve 130 from the antenna 125 at the cuff of wearable sleeve 130 to the opposite end of wearable sleeve 130 and extending outside of wearable sleeve 130, as shown in FIG. 2, so that it can be electrically connected to the RFID reader 120. In one example, one end of wired connection 132 is permanently connected to antenna 125, while the opposite end of the wired connection 132 is connected to the RFID reader 120 in a non-permanent fashion. For example, one end of wired connection 132 can be connected to the RFID reader 120 via plug and jack interface (not shown). In this way, RFID reader 120 can be connected and disconnected from any wearable sleeve 130 as needed.

FIG. 2 also shows an example of computing device 140. In this example, computing device 140 is a portable tablet device, such as, but not limited to, an Apple® iPad® or a Samsung Galaxy® Tab. The tablet device is non-sterile and non-disposable. Accordingly, the tablet device must be kept clear of the surgical field. In this example, the tablet device is connected wirelessly to both the RFID reader 120 and the server 160. The objects monitoring software 145 provides a user interface. For example, a system graphical user interface (GUI) 170 is displayed on the tablet device, which is the computing device 140. More details of an example of the system GUI 170 are shown and described with reference to FIG. 3, FIG. 4, and FIG. 5.

Referring once again to FIG. 2, objects monitoring system 100 also can include a video monitor or screen 190, which can display information from RFID reader 120. Video monitor or screen 190 can display information directly from RFID reader 120 or can display information processed by computing device 140. In some embodiments, the information displayed on video monitor or screen 190 is the same as the information displayed through system GUI 170. Video monitor or screen 190 can be mounted or worn on a user's wrist or forearm for convenience of viewing during operation. All the information collected by objects monitoring system 100 can be automatically collected by the system and displayed on video monitor or screen 190 and integrated with computing device 140 and associated network 180.

Referring to FIG. 3, FIG. 4, and FIG. 5, the system GUI 170 includes various controls and indicators, as well as a viewing area for displaying a list of the tagged objects 110 that are detected via the RFID reader 120. In one example, the system GUI 170 includes controls that allow the user to select either a “check out” mode or a “check in” mode of operation. For example, the system GUI 170 provides a “Check Out” pushbutton and a “Check In” pushbutton. In another example, a single pushbutton is provided that toggles between “check out” mode and “check in” mode. Further, the system GUI 170 may include certain status indicators. For example, the system GUI 170 provides a “Count Cleared” indicator and a “Count Error” indicator. The system GUI 170 may also use color to convey certain status or meaning.

Referring now to FIG. 3, at the beginning of the surgical procedure the user selects the “check out” mode of operation by selecting the “Check Out” pushbutton. In the “check out” mode of operation, the “Check In” pushbutton, the “Count Cleared” indicator, and the “Count Error” indicator are grayed out to indicate that they are inactive. In the “check out” mode of operation, as the tagged objects 110 enter the surgical field, the tagged objects 110 are detected by the RFID reader 120 and added to a list in the main viewing area of the system GUI 170, which is the contents of the checked out list 150 generated by the objects monitoring software 145. The contents of the checked out list 150 is continuously active and updated throughout the duration of the surgical procedure as the tagged objects 110 enter the surgical field. Accordingly, the display of the tagged objects 110 that are checked out is active and continuously updated in the system GUI 170 throughout the duration of the surgical procedure. Further, the total count of tagged objects 110 detected during the surgical procedure is dynamically updated.

Referring now to FIG. 4, at the completion of the surgical procedure the user selects the “check in” mode of operation by selecting the “Check In” pushbutton. In the “check in” mode of operation, the “Check Out” pushbutton is grayed out to indicate that it is inactive. In the “check in” mode of operation, as tagged objects 110 exit the surgical field, the tagged objects 110 are detected by the RFID reader 120 and the checked in list 155 is generated by objects monitoring software 145. Since the contents of the checked in list 155 is to be reconciled with the contents of the checked out list 150, such reconciliation can be indicated using color to indicate the status of each tagged object 110 that is displayed in the system GUI 170. For example, as each tagged object 110 is detected exiting the surgical field, the line displaying the detected tagged object 110 turns, for example, from black text to green text. When all tagged objects 110 exiting the surgical field match all tagged objects 110 that entered the surgical field, that is when the contents of the checked out list 150 matches the contents of the checked in list 155, all line items are changed from black text to green text, the total count line turns from black text to green text, and the “Count Cleared” indicator is activated. Namely, the objects monitoring software 145 uses the “Count Cleared” indicator and the color green to indicate a successful reconciliation between the checked out list 150 and the checked in list 155.

By contrast and referring now to FIG. 5, any tagged objects 110 in the checked out list 150 that are missing from the checked in list 155 can be indicated in the list by, for example, changing the black text to red text, as well as indicating the total count in red text. Further, the objects monitoring software 145 uses the “Count Error” indicator and the color red to indicate a failed reconciliation between the checked out list 150 and the checked in list 155.

Other indicators, such as audible or tactile (e.g., vibration) indicators, also can be used to indicate a failed reconciliation. Further, upon a failed reconciliation, a phone call can be initiated or a text message or email message can be generated and directed to one or more participants in the surgical procedure. In other embodiments, a voice interface can be used, whereby the system will provide audible information regarding the type instrument, the number of instruments, or the proximity of the instrument to the probe.

The system GUI 170 of the objects monitoring software 145 is not limited to the GUI shown in FIG. 3, FIG. 4, and FIG. 5; this is exemplary only. The system GUI 170 can be designed in any fashion and may be different from one type of computing device 140 to another type of computing device 140. For example, the system GUI 170 for a tablet device or mobile phone may be different than the system GUI 170 for a laptop or desktop computer.

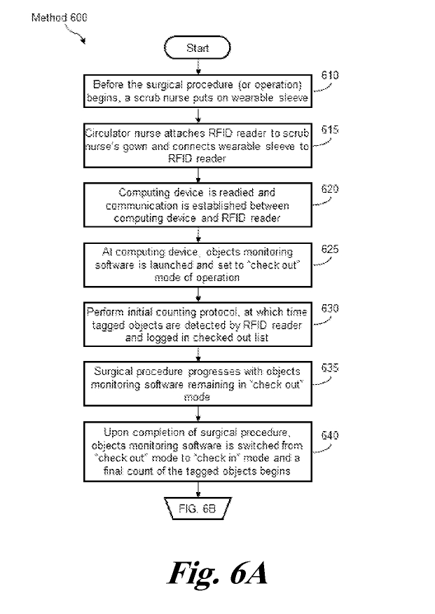

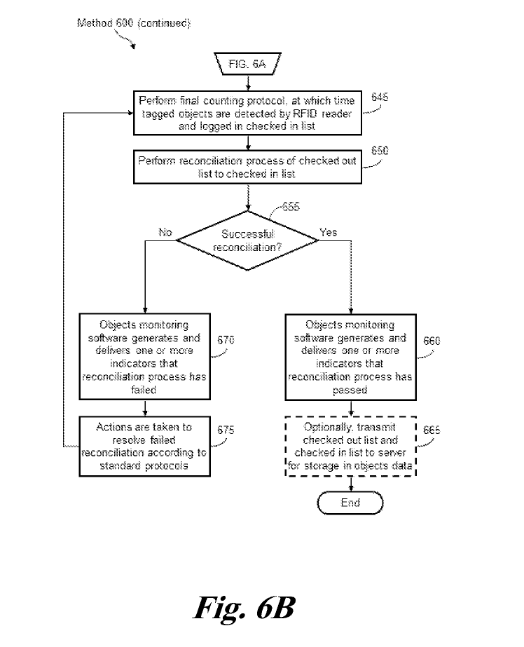

FIG. 6 illustrates a flow diagram of an example of a method 600 using the presently disclosed objects monitoring system 100 to automatically track objects during surgical procedures. Method 600 may include, but is not limited to, the following steps.

At a step 610, before the surgical procedure (or operation) begins, a scrub nurse puts on the wearable sleeve 130. The wearable sleeve 130 is introduced to the operating room in a sterile package like other sterile, disposable surgical garments. According to operating room protocols, a scrub nurse assists surgeons in the operating room. They are responsible for arranging all necessary equipment and handing them to the surgeon when called. At the end of the procedure, it is the scrub nurse's job to make sure that all of the equipment is accounted for.

At a step 615, the circulator nurse attaches the RFID reader 120 to the back of the scrub nurse's surgical gown and connects the wired connection 132 of the wearable sleeve 130 to the RFID reader 120. According to operating room protocols, a circulator is a nurse who works in surgical operating rooms monitoring the procedures. The circulator nurse does not scrub in, and performs job duties that cannot be done by staff that is scrubbed in. The circulator nurse works side by side with scrub nurses to help maintain a safe and sterile field in the operating room.

At a step 620, the computing device 140, such as the tablet device shown in FIG. 2, FIG. 3, FIG. 4, and FIG. 5, is readied and communication is established between, for example, the tablet device and the RFID reader 120.

At a step 625, using the computing device 140, such as the tablet device, the circulator nurse launches the objects monitoring software 145 and sets the objects monitoring software 145 to the “check out” mode of operation, as shown, for example, in FIG. 3.

At a step 630, the standard initial counting protocol is performed by the scrub nurse. Namely, an initial count of the tagged objects 110 is performed by the scrub nurse who is wearing the wearable sleeve 130. During this counting process, each time a tagged object 110 is handled and comes into close proximity to the wrist portion of the wearable sleeve 130, its RFID tag 115 is read and the ID number is transmitted from the RFID reader 120 to the computing device 140. Then, the objects monitoring software 145 records the ID number of that tagged object 110 in the checked out list 150 and the checked out-object count is incremented by 1. The contents of the checked out list 150 is displayed on the tablet device (i.e., at computing device 140) as shown, for example, in FIG. 3.

At a step 635, the surgical procedure progresses with the objects monitoring software 145 remaining in the “check out” mode of operation. Because the objects monitoring software 145 remains in “check out” mode during the course of the surgical procedure, if during the procedure the surgeon requests additional tagged objects 110, they can be added to the checked out list 150 and introduced to the surgery without any extra steps. Further, during the course of the surgical procedure, objects monitoring software 145 ignores any subsequent detection of a tagged object 110 that is already recorded in the checked out list 150. However, the first detection of any tagged object 110 that is introduced to the surgical field at any time is recorded in the checked out list 150 and the checked out-object count is incremented by 1. That is, the objects monitoring software 145 keeps an active count and record of the tagged objects 110, which can be accessed at any point in the surgical procedure. The contents of the checked out list 150 continues to be displayed on the tablet device (i.e., at computing device 140) as shown, for example, in FIG. 3. Further, medical personnel can grab a plurality of surgical instruments tagged with RFID tags simultaneously, and the presently disclosed objects monitoring system can count and identify all of the tagged surgical instruments held, for example, in one hand.

At a step 640, upon completion of the surgical procedure, a final count of the tagged objects 110 is initiated. For example, using the computing device 140, such as the tablet device, the circulator nurse switches the objects monitoring software 145 from the “check out” mode to the “check in” mode of operation, as shown, for example, in FIG. 4 and FIG. 5.

At a step 645, the scrub nurse who is wearing the wearable sleeve 130 performs the standard final counting protocol. Once again, as each tagged object 110 is handled and comes into close proximity to the wrist portion of the wearable sleeve 130, its RFID tag 115 is read and the ID number is transmitted from the RFID reader 120 to the computing device 140. Then, the objects monitoring software 145 records the ID number in the checked in list 155 and the checked in-object count is incremented by 1. The contents of the checked in list 155 can be indicated on the tablet device (i.e., at computing device 140) as shown, for example, in FIG. 4 and FIG. 5.

At a step 650, throughout the check in process, the objects monitoring software 145 attempts to reconcile the contents of the checked out list 150 and the contents of the checked in list 155. Reconciled means the number of tagged objects 110 and the IDs of the tagged objects 110 is the same in both the checked out list 150 and the checked in list 155. The status of the reconciliation process can be indicated on the tablet device (i.e., at computing device 140) as shown, for example, in FIG. 4 and FIG. 5.

At a decision step 655, it is determined whether the reconciliation process has passed or failed. For example, if there are no discrepancies between the checked out list 150 and the checked in list 155, then all of the tagged objects 110 are accounted for and the reconciliation has passed and method 600 proceeds to step 660. If any discrepancies between the checked out list 150 and the checked in list 155 exist, however, then all of the tagged objects 110 are not accounted for and the reconciliation has failed and method 600 proceeds to step 670.

At a step 660, the objects monitoring software 145 generates and delivers one or more indicators that the reconciliation process has passed. For example, the objects monitoring software 145 uses the “Count Cleared” indicator and the color green to indicate a successful reconciliation between the checked out list 150 and the checked in list 155. Other indicators, such as audible or tactile (e.g., vibration) indicators, can also be used to indicate a successful reconciliation. Further, upon a successful reconciliation, a phone call can be initiated or a text message or email message can be generated and directed to one or more participants in the surgical procedure, such as to the circulator nurse. An example of the “Count Cleared” status is shown in FIG. 4. Method 600 ends or optionally proceeds to step 665.

At an optional step 665, the checked out list 150 and the checked in list 155, along with a surgical procedure identifier is transmitted from the computing device 140 to the server 160 and stored in the objects data 165. Method 600 ends.

At a step 670, the objects monitoring software 145 generates and delivers one or more indicators that the reconciliation process has failed and of the ID and number of potentially missing tagged objects 110. For example, the objects monitoring software 145 uses the “Count Error” indicator and the color red to indicate an unsuccessful reconciliation between the checked out list 150 and the checked in list 155. Other indicators, such as audible or tactile (e.g., vibration) indicators, can also be used to indicate an unsuccessful reconciliation. Further, upon an unsuccessful reconciliation, a phone call can be initiated or a text message or email message can be generated and directed to one or more participants in the surgical procedure, such as to the circulator nurse. An example of the “Count Error” status is shown in FIG. 5.

At a step 675, actions are taken to resolve the failed reconciliation according to standard protocols. For example, if the tagged objects 110 are found, they must simply be handled by the scrub nurse who is wearing the wearable sleeve 130 to be “checked in” and added to the checked in list 155. If the missing tagged objects 110 are not found, standard procedures are followed, such as X-raying the patient, until such time that all of the tagged objects 110 are accounted for. Additionally, the wearable sleeve 130 may be passed on close proximity to the patient to see if any tagged objects 110 are detected inside the patient. For example, the objects monitoring software 145 may have a “search” mode of operation, which graphically indicates any tagged objects 110 detected (inside or outside the patient) during a search operation. Method 600 returns to step 645.

Accordingly, the objects monitoring software can be operated in a “find” or “search” mode, whereby medical personnel, e.g., a surgeon or a nurse, can use the presently disclosed system to find a missing surgical instrument. In this mode, the count is not affected, but the system can register whether an instrument is close to or in proximity to the probe, e.g., wearable sleeve 130. In such embodiments, the range of the RFID antenna 125 can be extended beyond a 6-inch radius, e.g., to a 24-inch radius. Such embodiments also can include a vectoring system to allow locating the missing instrument.

The presently disclosed objects monitoring system also can be used to tally surgical instruments outside of the operating room. For example, a container comprising a plurality of RFID-tagged surgical instruments, e.g., a box of tagged surgical sponges, can be picked up by medical personnel wearing the presently disclosed objects monitoring system, which can count the tagged surgical instruments through the container without compromising, e.g., breaking, sterility. In such applications, the medical personnel does not need to be sterile to count the instruments.

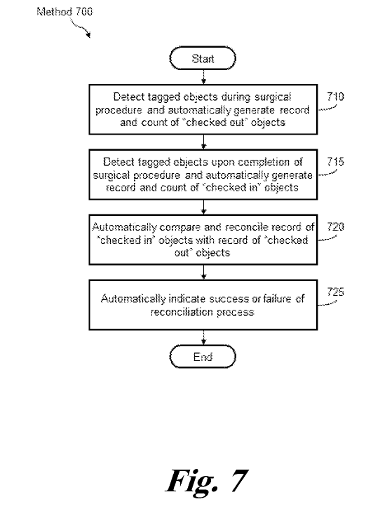

FIG. 7 illustrates a flow diagram of an example of a method 700 of operation of the presently disclosed objects monitoring system 100 according to a simple configuration. Method 700 may include, but is not limited to, the following steps.

At a step 710, during the surgical procedure and with the objects monitoring software 145 in the “check out” mode of operation, tagged objects 110 are automatically detected using the RFID reader 120. Then, using the objects monitoring software 145, a record and count of “checked out” tagged objects 110 is automatically generated. For example, the checked out list 150 is automatically generated.

At a step 715, upon completion of the surgical procedure and with the objects monitoring software 145 in the “check in” mode of operation, tagged objects 110 are automatically detected using the RFID reader 120. Then, using the objects monitoring software 145, a record and count of “checked in” tagged objects 110 is automatically generated. For example, the checked in list 155 is automatically generated.

At a step 720, the record of “checked in” tagged objects 110 is automatically compared and reconciled with the record of “checked out” tagged objects 110. For example, using the objects monitoring software 145, the record of tagged objects 110 in the checked in list 155 is automatically compared and reconciled with record of “tagged objects 110 in the checked out list 150.

At a step 725, the success or failure of the reconciliation process is automatically indicated. For example, using the objects monitoring software 145, the success or failure of the reconciliation process is automatically indicated, for example, via indicators of the system GUI 170 or by any other means, such as audible indictors, tactile indicators, phone calls, text messages, emails, and any combinations thereof.

The subject treated by the presently disclosed methods in their many embodiments is desirably a human subject, although it is to be understood that the methods described herein are effective with respect to all vertebrate species, which are intended to be included in the term “subject.”

A “subject” can include a human subject for medical purposes, such as for the treatment of an existing condition or disease or the prophylactic treatment for preventing the onset of a condition or disease, or an animal subject for medical, veterinary purposes, or developmental purposes. Suitable animal subjects include mammals including, but not limited to, primates, e.g., humans, monkeys, apes, and the like; bovines, e.g., cattle, oxen, and the like; ovines, e.g., sheep and the like; caprines, e.g., goats and the like; porcines, e.g., pigs, hogs, and the like; equines, e.g., horses, donkeys, zebras, and the like; felines, including wild and domestic cats; canines, including dogs; lagomorphs, including rabbits, hares, and the like; and rodents, including mice, rats, and the like. An animal may be a transgenic animal. In some embodiments, the subject is a human including, but not limited to, fetal, neonatal, infant, juvenile, and adult subjects. Further, a “subject” can include a patient afflicted with or suspected of being afflicted with a condition or disease. Thus, the terms “subject” and “patient” are used interchangeably herein.

Following long-standing patent law convention, the terms “a,” “an,” and “the” refer to “one or more” when used in this application, including the claims. Thus, for example, reference to “a subject” includes a plurality of subjects, unless the context clearly is to the contrary (e.g., a plurality of subjects), and so forth.

Throughout this specification and the claims, the terms “comprise,” “comprises,” and “comprising” are used in a non-exclusive sense, except where the context requires otherwise. Likewise, the term “include” and its grammatical variants are intended to be non-limiting, such that recitation of items in a list is not to the exclusion of other like items that can be substituted or added to the listed items.

For the purposes of this specification and appended claims, unless otherwise indicated, all numbers expressing amounts, sizes, dimensions, proportions, shapes, formulations, parameters, percentages, parameters, quantities, characteristics, and other numerical values used in the specification and claims, are to be understood as being modified in all instances by the term “about” even though the term “about” may not expressly appear with the value, amount or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the presently disclosed subject matter. For example, the term “about,” when referring to a value can be meant to encompass variations of, in some embodiments, ±100% in some embodiments ±50%, in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

### REFERENCES

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

U.S. Patent Application Publication No. US20020044058 for Wrist Mounted RFID Reader and/or Antenna, to Heinrich et al., published Apr. 18, 2002;

U.S. Patent Application Publication No. 20100097195 for Data Interface Process with RFID Data Reader Glove, to Majoros, et al., published Apr. 22, 2010;

Fishkin, K. P., Hands-on RFID: Wireless Wearables for Detecting Use of Objects, in Ninth IEEE International Symposium on Wearable Computers, Oct. 18-21, 2005, pp. 38-41.

International PCT Patent Application Publication No. WO2007016101 for Method and System for Configuring and Data Populating a Surgical Device, to Charles, et al., published Feb. 8, 2007; and

European Patent Application Publication No. EP2460488 for Surgical Glove Appliance Device, to Kantrowitz and Mun, published Jun. 6, 2012.

Although the foregoing subject matter has been described in some detail by way of illustration and example for purposes of clarity of understanding, it will be understood by those skilled in the art that certain changes and modifications can be practiced within the scope of the appended claims.

That which is claimed:

1. A system for identifying and tracking one or more objects used in a surgical procedure, the system comprising a radio-frequency identification (RFID) reader, a wearable article comprising an antenna or a standalone antenna in electrical communication with the RFID reader, and one or more RFID tags for tagging, identifying, and tracking objects used in a surgical procedure.

2. The system of claim 1, wherein the RFID tag comprises a passive RFID tag.

3. The system of claim 1, wherein the RFID tag comprises one or more pieces of stored information selected from the group consisting of a unique identification number for an object, a chain of custody history of an object, a sanitation or cleaning history of an object, a type of object, and a brand of object.

4. The system of claim 1, further comprising a computing device in communication with the RFID reader.

5. The system of claim 4, wherein the computing device communicates with the RFID reader via a connection selected from the group consisting of a wired connection and a wireless connection.

6. The system of claim 4, wherein the computing device further comprises executable monitoring software.

7. The system of claim 1, further comprising a server.

8. The system of claim 1, wherein the one or more objects used in a surgical procedure comprises one or more surgical instruments.

9. The system of claim 8, wherein the one or more surgical instruments are selected from the group consisting of a scalpel, a grasper, forceps, scissors, a clamp, a retractor, a distractor, a probe, a snare, a curet, a needle, a saw, a sponge, a surgical lap pad, a suction tool, a drill, and a dermatome.

10. The system of claim 1, wherein the wearable article is disposable.

11. A method for identifying and tracking one or more objects used in a surgical procedure, the method comprising:
providing a radio-frequency identification (RFID) reader, a wearable article comprising an antenna or a standalone antenna in electrical communication with the RFID reader, and one or more RFID tags for tagging, identifying, and tracking objects used in a surgical procedure;
detecting one or more tagged objects using the RFID reader prior to or during the surgical procedure;
generating a record and count of the one or more detected tagged objects prior to or during the surgical procedure;
detecting one or more tagged objects using the RFID reader after the surgical procedure;
generating a record and count of the one or more detected tagged objects after the surgical procedure;
reconciling the record and count of the one or more detected tagged objects prior to or during the surgical procedure to the record and count of the one or more detected tagged objects after the surgical procedure; and
indicating a success or failure of the reconciliation of the record and count of the one or more detected tagged objects prior to or during the surgical procedure to the record and count of the one or more detected tagged objects after the surgical procedure.

12. The method of claim 11, wherein the indicating is accomplished via a graphical user interface, an audible alarm, a visible alarm, a tactile indicator, a phone call, a text message, an email communication, a voice interface, and combinations thereof.

13. The method of claim 11, wherein the one or more objects used in a surgical procedure comprise one or more sterile surgical instruments comprising a sterile container.

14. The method of claim 13, wherein the one or more sterile surgical instruments are identified and tracked outside of an operating room.

15. A method for locating one or more objects used in a surgical procedure, the method comprising:
providing a radio-frequency identification (RFID) reader, a wearable article comprising an antenna or a standalone antenna in electrical communication with the RFID reader, and one or more RFID tags for tagging, identifying, and tracking objects used in a surgical procedure;
scanning an area suspected of comprising one or more objects used in a surgical procedure with the wearable article or standalone antenna; and
detecting one or more objects used in a surgical procedure.
